(19) United States
(12) Patent Application Publication
(10) Pub. No.: US 2024/0073640 A1
(43) Pub. Date: Feb. 29, 2024

(54) IDENTIFYING A LOCATION OF A FACILITY UNIT

(71) Applicant: Janus International Group, LLC, Temple, GA (US)

(72) Inventors: William Debord, Woodstock, GA (US); Christine Debord, Canton, GA (US); David P. Gengler, Draper, UT (US); Nathan Perry, Eagle Mountain, UT (US)

(21) Appl. No.: 18/456,717

(22) Filed: Aug. 28, 2023

Related U.S. Application Data
(60) Provisional application No. 63/401,923, filed on Aug. 29, 2022.

(51) Int. Cl. H04W 4/021; G08B 7/06; H04W 4/024

(52) U.S. Cl. CPC H04W 4/021; G08B 7/06; H04W 4/024; H04W 88/16

(57) ABSTRACT

The present disclosure includes devices, systems, and methods for locating a unit within a storage facility. Such locating may include receiving request, for example, by a gateway device, for one or more units of a storage facility, generating a control signal to activate notification in the unit device co-located with the unit, and transmitting the control signal accordingly to allow indication of the physical location.

### CROSS-REFERENCE

This utility application claims the benefit of priority to provisional application No. 63/401,923, filed on Aug. 29, 2022, the contents of which are hereby incorporated by reference in their entirety, including without limitation, those portions concerning location identification.

### FIELD

The present disclosure generally relates to a system and techniques for identifying a location of a unit within a facility, such as a self-storage facility.

Self-storage facilities rent storage space to tenants such as individuals and businesses. A self-storage facility may separate its storage space by unit. While a unit can be anything from lockers, containers, to even outdoor spaces, a typical unit often corresponds to an enclosed and climate-controlled room that is accessible via a lockable door. A self-storage facility may grant access to a given unit though various means, such as a physical key, a unique code to be input on a keypad, a digital key generated using tenant credentials, and the like.

Generally, a self-storage facility has numerous units that have a uniform exterior. This can pose an issue for a tenant in locating a rented unit within the facility. Although the facility may provide maps and signage indicating a general area in which the rented unit is located, the tenant may nevertheless have difficulty navigating to the unit, especially if the facility has a large square footage.

### SUMMARY

Within the present disclosure, various embodiments can include a system and techniques for locating a unit within a facility, such as a self-storage facility.

According to an aspect of the present disclosure, a method for locating a unit within a storage facility may include receiving, by a gateway device, a request generated by a mobile device to locate a specified unit of a plurality of units within the storage facility, wherein each of the plurality of units is co-located with a unit device; generating, based on the request and by the gateway device, a control signal to activate notification in the unit device associated with the specified storage unit; and transmitting, by the gateway device, the control signal to the unit device associated with the specified storage unit to cause the unit device to emit an audio and/or visual indication of its physical location. In some embodiments, the facility may be a self-storage facility. The gateway device may transmit the control signal to the plurality of units via a WirePas communication protocol.

In some embodiments, transmitting the control signal may include transmitting an indication of a device ID representative of the unit device associated with the specified unit to units devices located within a network proximity. In some embodiments, the method may further include determining whether the indication of the device ID is representative of a specific unit device which received the control signal. Transmitting may include activating emission of the audio and/or visual indication from the specific unit device responsive to determination that the indication of device ID is representative of the specific unit device. In some embodiments, determining is performed at least partially by the specific unit device.

In some embodiments, transmitting may include further transmitting an indication of the device ID representative of the unit device associated with the specified unit to other units devices located within another network proximity. The further transmitting may be conducted in response to determination that the indication of device ID is not representative of a specific unit device. The further transmitting may include repeating the indication of device ID by the specific unit device to the other unit devices.

In some embodiments, the network proximity may be defined relative to the specific unit device. Determining may be performed at least partially by the specific unit device. The request may include a request to locate more than one specified unit.

In some embodiments, the visual indication of its physical location may include directions from a known location and/or the mobile device location. The visual indication of its physical location may include a map indicating the physical location within the storage facility.

According to another aspect of the present disclosure, a storage facility system may include a plurality of unit devices, wherein each of the plurality of unit devices is co-located with a unit of the storage; and a gateway device configured for receiving request to locate a specified unit of a storage facility, for generating responsive to the request, a control signal to activate notification in the unit device associated with the specified storage unit, and for transmitting the control signal to the unit device associated with the specified storage unit to cause the unit device to emit an audio and/or visual indication of its physical location. In some embodiments, the gateway device may be configured to transmit the control signal to the plurality of units via a WirePas communication protocol. Transmitting the control signal may include transmitting an indication of a device ID representative of the unit device associated with the specified unit to units devices located within a network proximity.

In some embodiments, the gateway device may be further configured for determining whether the indication of the device ID is representative of a specific unit device which received the control signal. Transmitting may include activating emission of the audio and/or visual indication from the specific unit device responsive to determination that the indication of device ID is representative of the specific unit device. Determining may be performed at least partially by the specific unit device.

In some embodiments, transmitting may include further transmitting an indication of the device ID representative of the unit device associated with the specified unit to other units devices located within another network proximity. Further transmitting may be conducted in response to determination that the indication of device ID is not representative of a specific unit device. Further transmitting may include repeating the indication of device ID by the specific unit device to the other unit devices.

In some embodiments, the network proximity may be defined relative to the specific unit device. The request may be received from a mobile device. In some embodiments, a storage facility may include the storage facility system.

### BRIEF DESCRIPTION

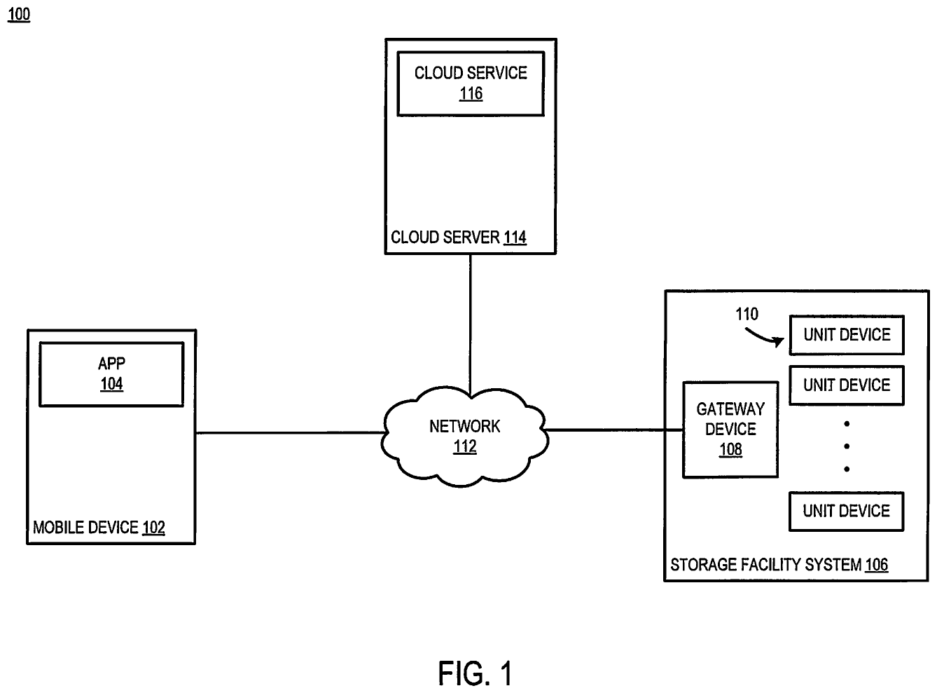

FIG. 1 illustrates an example environment in which a mobile device may interface with a storage facility system to physically locate a registered unit within the system, according to an embodiment;

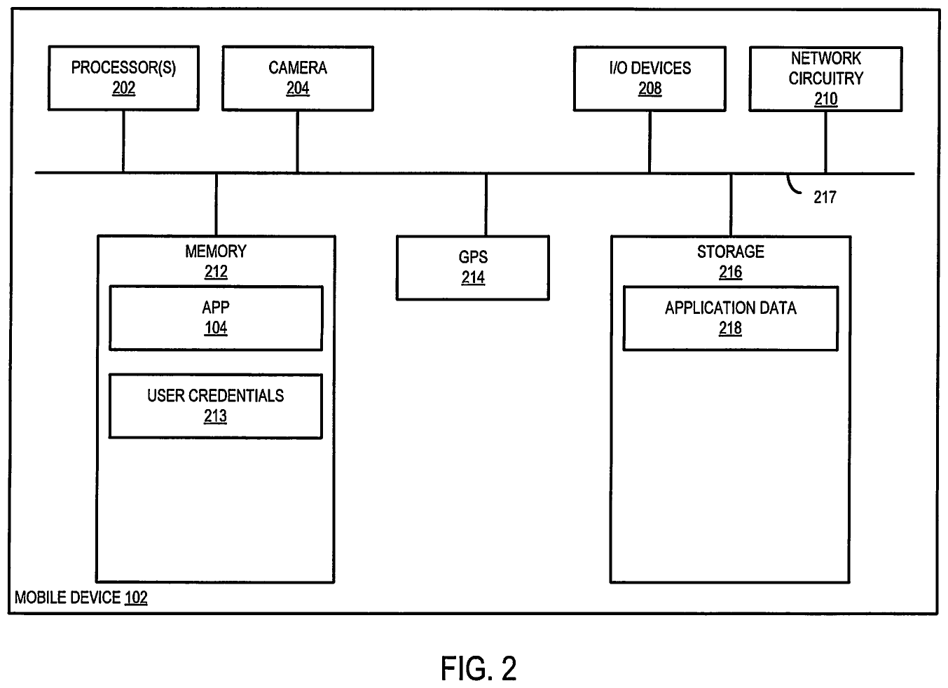

FIG. 2 illustrates a block diagram of the mobile device described relative to FIG. 1, according to an embodiment;

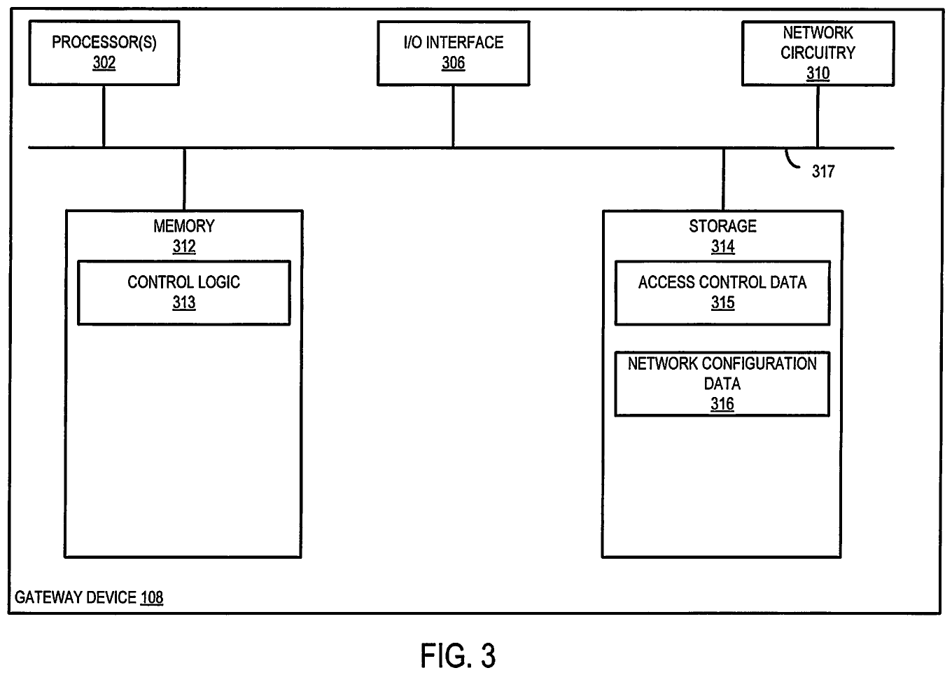

FIG. 3 illustrates a block diagram of the gateway described relative to FIG. 1, according to an embodiment;

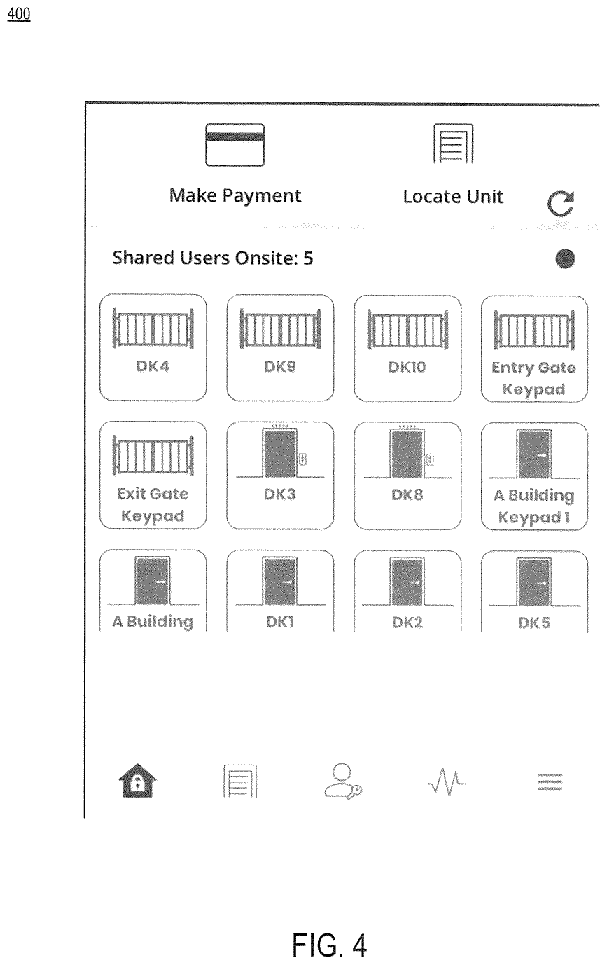

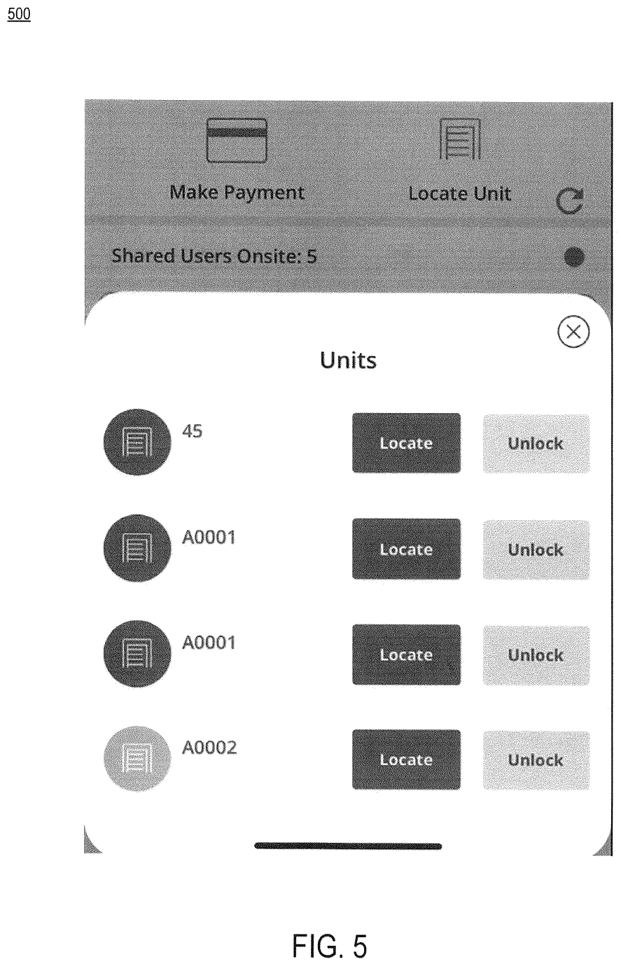

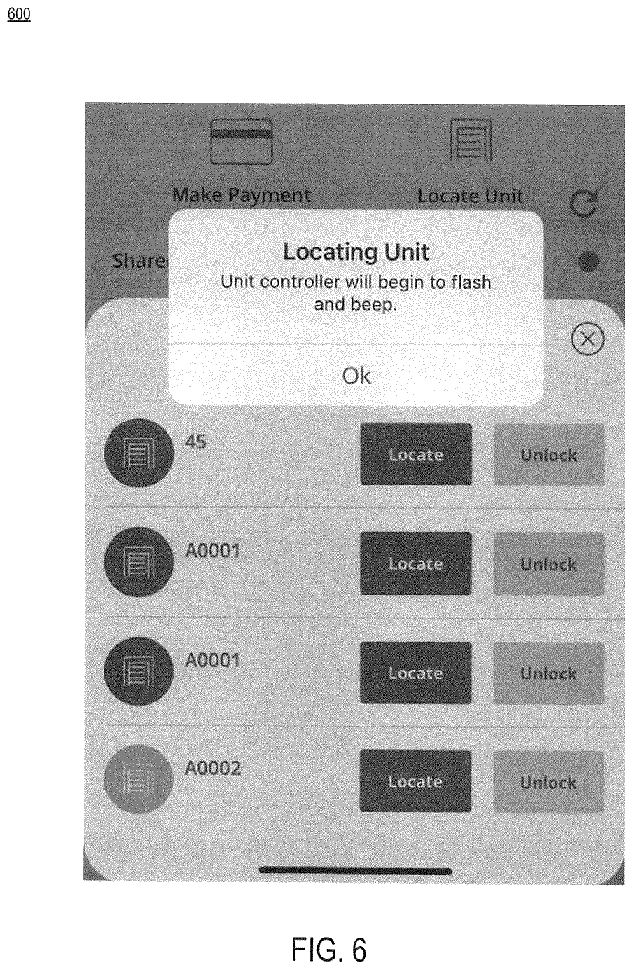

FIGS. 4-6 illustrate application user interfaces displayed by the mobile device of FIG. 1 to enable location of a physical unit within a storage facility system; and

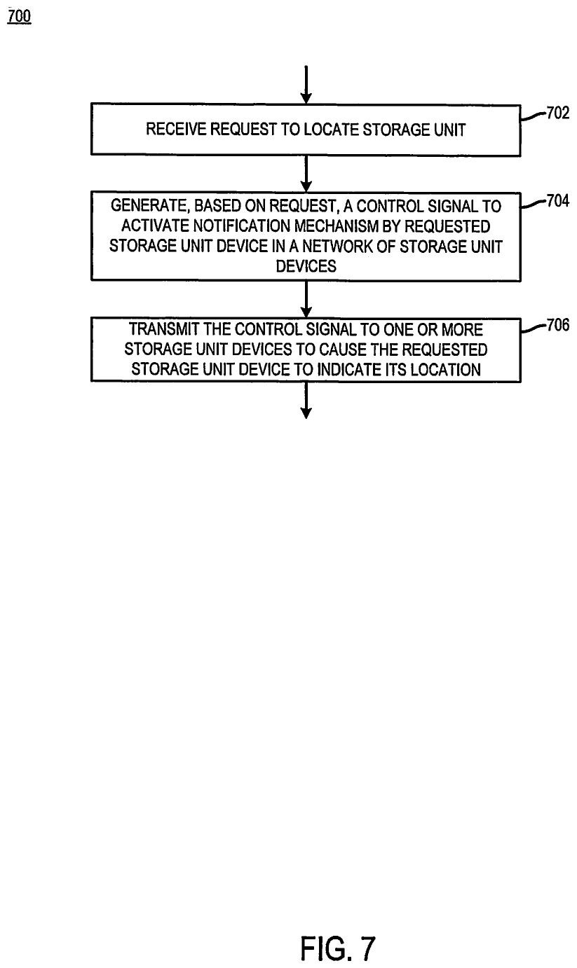

FIG. 7 illustrates a flow diagram of an example method for locating a unit within a storage facility system, according to an embodiment.

### DETAILED DESCRIPTION

Embodiments presented herein disclose a system and techniques for identifying a location of a unit within a facility, such as a self-storage facility. More particularly, embodiments provide a networked system of devices stored in, on, or around each unit of the self-storage facility. The devices are in communication with a centralized gateway device that manages device operation and is connected with a larger network such as the Internet. Embodiments further provide an application (executable by a mobile device) that allows a tenant user to communicate with the gateway device. In an embodiment, the application provides a unit location function, which, when activated by the tenant user, causes the gateway to trigger a wireless communication mechanism to the networked unit devices to locate a device that is registered to the tenant user. The registered unit device, in response to receiving the communication from the gateway, performs an action to signal its location to a tenant user, such as activating a visual and/or audio indicator (e.g., a light, a beeping noise, etc.) from its location. Advantageously, the embodiments disclosed provides a wireless solution that enables a tenant user to locate a registered facility unit, such as a self-storage unit, without requiring that the user has any additional equipment other than a mobile device.

The following detailed description includes references to the accompanying figures. In the figures, similar symbols typically identify similar components, unless context dictates otherwise. The example embodiments described herein are not meant to be limiting. Other embodiments may be utilized, and other changes may be made, without departing from the scope of the subject matter presented herein. It will be readily understood that the aspects of the present disclosure, as generally described herein and illustrated in the figures can be arranged, substituted, combined, separated, and designed in a wide variety of different configurations, all of which are contemplated herein.

FIG. 1 illustrates an example computing environment 100 in which a mobile device 102 may interface with a storage facility system 106 (via a cloud service 116 hosted on a cloud server 114) to physically locate a registered unit within a self-storage facility, according to an embodiment. As shown, the mobile device 102, storage facility system 106, and cloud server 114 are connected to a network 112 (e.g., the Internet).

The mobile device 102 may be embodied as any physical computing device accessible by a user (e.g., a tenant user, an operator or employee of the storage facility system 106, a system administrator, etc.) having wireless communication functionality, such as a smart phone, smart tablet, laptop device, etc. The mobile device 102 may be owned by a tenant user, a device located on-site at the underlying self-storage facility, a device located remotely from the self-storage facility (e.g., at a management console associated with the self-storage facility), and so on. Illustratively, the mobile device 102 also includes an app 104. As further described herein, the app 104 allows the user to interface with the storage facility system 106 and access a variety of features provided by the system 106, including locating a self-storage unit associated with the user.

In an embodiment, the storage facility system 106 comprises a local network (different from the network 112) of interconnected devices to control various features of the underlying self-storage facility, such as unit door control, HVAC settings and temperature control, tenant access, facility monitoring, and so on, in addition to the unit location techniques described herein. Illustratively, the storage facility system 106 includes a gateway device 108 and one or more unit devices 110. The cloud server 114 may be embodied as one or more physical or virtual computing resources pooled together to provide cloud-based services, such as the cloud service 116. The cloud service 116 processes requests sent by the app 104 and transmits the processed requests to the storage facility system 106. The storage facility system 106 may also transmit information to the app 104 via the cloud service 116.

The gateway device 108 may be embodied as any physical computing or networking device (e.g., a router, hub device, switch, etc.) to communicate with devices within the storage facility system 106 and also with the cloud server 114. The unit devices 108 may be embodied as any physical computing or networking device (e.g., a networking beacon, an Internet-of-Things device, mobile device, etc.) that is co-located with an individual unit within the underlying storage facility. The gateway device 108 may communicate using wireless protocols (e.g., Bluetooth, WirePas, etc.) with the unit devices 110 to control the unit devices 110 or trigger the unit devices 110 to perform certain actions.

In an embodiment, the app 104 allows a tenant user to communicate with the gateway device 108 via the cloud service 116, authenticate credentials associated with the user, identify one or more self-storage units registered to the user, and access features associated with the identified units (e.g., locking and unlocking, temperature control, access control management, etc.) through a graphical user interface presented on a display of the mobile device 102. In addition, the app 104 enables the user to communicate with the cloud service 116, which in turn triggers the gateway device 108 to cause one or more of the unit devices 110 co-located with the underlying registered units of the tenant user to signal to the user their locations using an audiovisual indicator.

FIG. 2 further illustrates the mobile device 102, according to an example embodiment. As shown, the mobile device 102 includes, without limitation, one or more processors 202, a camera 204 and other I/O devices 208 coupled with an I/O device interface (not shown), network circuitry 210, a memory 212, a GPS 214, and a storage 216, each interconnected via a hardware bus 217. Of course, an actual mobile device 102 will include a variety of additional hardware components not shown.

The processor 202 retrieves and executes programming instructions stored in the memory 212, such as those of the app 104. Similarly, the processor 202 generates user credentials (e.g., dynamically generated login information and encryption/decryption keys, electronic unit key credentials, etc.) 213 as well as stores and retrieves application data 218 (e.g., tenant user configuration information, user data, registered unit data, etc.) associated with the app 104 residing in the storage 216. The hardware bus 217 is used to transmit instructions and data between the interconnected components. The processor 202 is included to be representative of a single CPU, multiple CPUs, a single CPU having multiple processing cores, and the like. The memory 212 is generally included to be representative of memory and storage on a mobile device, e.g., DDR and flash memory spaces. The network circuitry 210 may be embodied as any hardware, software, or circuitry (e.g., a network interface card) used to connect the mobile device 102 over the network 112 and providing the network communication functions described above.

The I/O device interface allows the camera 204 and other I/O devices 208 to communicate with hardware and software components of the mobile device 102. The I/O devices 208 may be embodied as any type of input/output device connected with or provided as a component to the mobile device 102, such as the speaker and microphone devices. I/O devices such as keyboards, mice, and printers may be included as I/O devices 212 (e.g., to print map of the storage facility indicating a location of a registered unit). As stated, the memory 212 includes the app 104 and user credentials 213.

FIG. 3 further illustrates the gateway device 108, according to an example embodiment. As shown, the gateway device 108 includes, without limitation, one or more processors 302, an I/O interface 306, a network circuitry 310, a memory 312, and a storage 314, each interconnected via a hardware bus 317. Of course, a gateway device 108 will include a variety of additional hardware components. Further, some components shown herein, such as the storage 314, can reside separate from the gateway device 108 (e.g., as cloud storage or a remote storage host).

The processor 302 retrieves and executes programming instructions stored in the memory 312, such as control logic 313. Similarly, the processor 302 stores and retrieves data residing in the storage 314, such as access control data 315 (providing access rules, policies, and user-to-unit registration data for the underlying storage facility) and network configuration data 316 (e.g., network topology information, unit device ID mappings to storage units, routing tables, etc.). The hardware bus 317 is used to transmit instructions and data between the processor 302, storage 314, network interface 310, and the memory 312. The processor 302 is included to be representative of a single CPU, multiple CPUs, a single CPU having multiple processing cores, and the like. The memory 312 is generally included to be representative of memory and storage on a mobile device, e.g., DDR and flash memory spaces. The network circuitry 310 may be embodied as any hardware, software, or circuitry (e.g., a network interface card) used to connect the gateway device 108 over one or more networks (e.g., to the network 112 and to a local area network) and providing the network communication functions described above.

The I/O interface 306 allows I/O devices (not shown) to communicate with hardware and software components of the gateway device 108. The I/O devices may be embodied as any type of input/output device that can be connected with or provided as a component to the gateway device 108, such as keyboards, mouse devices, and printers.

Illustratively, the memory 312 includes the control logic 313, which may be embodied as any hardware, software, or circuitry to process communications from the cloud service 116 and also format and transmit communications to unit devices 110 in response to communications from the app 104. Further, the storage 314 includes the aforementioned access control data 315 and network configuration data 316.

FIGS. 4-6 illustrate various views 400, 500, and 600, respectively, provided by a graphical user interface of the app 104, according to an example embodiment. The view 400 depicts three feature regions. The topmost feature region provides icons for payment and unit location features accessible by the user through the app 104. The middle feature region provides icons indicating different points of access within the self-storage facility, such as various gates (indicated by the gate icon), units (indicated by the unit door icon), and building entryways (indicated by the door icon). The bottommost feature region is provides navigation to other views provided by the graphical user interface of the app 104.

The view 500 depicts a pop up window that appears upon the user pressing the “Locate Unit” icon on the topmost feature region of the view 400. Illustratively, the window lists the units that the tenant user can access along with options for locating or unlocking the listed unit. The view 600 depicts a pop up window that appears upon the user pressing the “Locate” button on a given listed unit. The window indicates that a device within the unit will begin to flash and beep.

FIG. 7 illustrates a flow diagram of an example method 700 for locating a unit within a facility, such as a self-storage facility. As shown, the method begins in block 702, in which the gateway device 108 receives a request from the app 104 (relayed to the gateway device 108 by the cloud service 116) to locate a specified storage unit. The request may include information such as user access credentials (e.g., for validation of the user's access privileges), a unit ID, a type of indication to send to the user from the unit device (e.g., an audio indication, visual indication, coordinates sent to the phone, or some combination), and the like. In block 704, the gateway device 108 generates, based on the request, a control signal to activate the notification mechanism in the unit device. In block 706, the gateway device 108 transmits the control signal to the networked unit devices 110. The control signal may include information such as a device ID (e.g., mapped from the unit ID specified in the request) and type of indication. For instance, the gateway device 108 may use a wireless communication protocol such as WirePas, which sends the control signal to each unit device 110 within a network proximity to the gateway device 108. In turn, the unit device 110, once received, evaluates the control signal to determine whether the device ID in the signal matches that of the unit device 110. If not, the unit device 110 then repeats the control signal to other unit devices within a network proximity thereto. If the device ID matches, unit device 110 performs the indication to draw the user's attention to the location of the unit.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration only, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media which may be read and executed by one or more processors. A machine-readable medium may include any suitable form of volatile or non-volatile memory.

Modules, data structures, and the like defined herein are defined as such for ease of discussion, and are not intended to imply that any specific implementation details are required. For example, any of the described modules and/or data structures may be combined or divided in sub-modules, sub-processes or other units of computer code or data as may be required by a particular design or implementation of the computing device.

In the drawings, specific arrangements or orderings of elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relationships, or associations between elements may be simplified or not shown in the drawings so as not to obscure the disclosure.

This disclosure is considered to be exemplary and not restrictive. In character, and all changes and modifications that come within the spirit of the disclosure are desired to be protected. While particular aspects and embodiments are disclosed herein, other aspects and embodiments will be apparent to those skilled in the art in view of the foregoing teaching.

While the foregoing is directed to embodiments of the present disclosure, other and further embodiments of the disclosure may be devised without departing from the basic scope thereof, and the scope thereof is determined by the claims that follow.

What is claimed is:

1. A method for locating a unit within a storage facility comprising:
receiving, by a gateway device, a request generated by a mobile device to locate a specified unit of a plurality of units within the storage facility, wherein each of the plurality of units is co-located with a unit device;
generating, based on the request and by the gateway device, a control signal to activate notification in the unit device associated with the specified storage unit; and
transmitting, by the gateway device, the control signal to the unit device associated with the specified storage unit to cause the unit device to emit an audio and/or visual indication of its physical location.

2. The method of claim 1, wherein the facility is a self-storage facility.

3. The method of claim 1, wherein the gateway device transmits the control signal to the plurality of units via a WirePas communication protocol.

4. The method of claim 1, wherein transmitting the control signal includes transmitting an indication of a device ID representative of the unit device associated with the specified unit to units devices located within a network proximity.

5. The method of claim 4, further comprising determining whether the indication of the device ID is representative of a specific unit device which received the control signal.

6. The method of claim 5, wherein transmitting includes activating emission of the audio and/or visual indication from the specific unit device responsive to determination that the indication of device ID is representative of the specific unit device.

7. The method of claim 5, wherein determining is performed at least partially by the specific unit device.

8. The method of claim 5, wherein transmitting includes further transmitting an indication of the device ID representative of the unit device associated with the specified unit to other units devices located within another network proximity.

9. The method of claim 8, wherein the further transmitting is conducted in response to determination that the indication of device ID is not representative of a specific unit device.

10. The method of claim 9, wherein the further transmitting includes repeating the indication of device ID by the specific unit device to the other unit devices.

11. The method of claim 10, wherein the network proximity is defined relative to the specific unit device.

12. The method of claim 9, wherein determining is performed at least partially by the specific unit device.

13. The method of claim 1, wherein the request includes a request to locate more than one specified unit.

14. The method of claim 1, wherein the visual indication of its physical location includes directions from a known location and/or the mobile device location.

15. The method of claim 1, wherein the visual indication of its physical location includes a map indicating the physical location within the storage facility.

16. A storage facility system comprising:
a plurality of unit devices, wherein each of the plurality of unit devices is co-located with a unit of the storage; and
a gateway device configured for receiving request to locate a specified unit of a storage facility, for generating responsive to the request, a control signal to activate notification in the unit device associated with the specified storage unit, and for transmitting the control signal to the unit device associated with the specified storage unit to cause the unit device to emit an audio and/or visual indication of its physical location.

17. The storage facility system of claim 16, wherein the gateway device is configured to transmit the control signal to the plurality of units via a WirePas communication protocol.

18. The storage facility system of claim 16, wherein transmitting the control signal includes transmitting an indication of a device ID representative of the unit device associated with the specified unit to units devices located within a network proximity.

19. The storage facility system of claim 18, the gateway device is configured for determining whether the indication of the device ID is representative of a specific unit device which received the control signal.

20. The storage facility system of claim 19, wherein transmitting includes further transmitting an indication of the device ID representative of the unit device associated with the specified unit to other units devices located within another network proximity.
